(19) United States
(12) Patent Application Publication
(10) Pub. No.: US 2003/0126808 A1
(43) Pub. Date: Jul. 10, 2003

(54) Off-the-ground cemetery memorials

(76) Inventor: Lawrence L. Helwig, Brookings, SD (US)

Correspondence Address: Lawrence L. Helwig, 319 Dogwood Ave., Brookings, SD, 57006, US

(21) Appl. No.: 10/040,624

(22) Filed: Jan. 9, 2002

(51) Int. Cl. G09F 19/00

(52) U.S. Cl. 52/103; 52/102; 52/104

(57) ABSTRACT

An invention for cemeteries that unifies cemetery displays and the burial monument, and does away with the clutter of ground level displays. It has a receiving base adapted for attaching numerous displays. The receiving base is bonded to the monument or its base at an elevation that will reduce problems being experienced by maintenance personnel. The attachment is achieved by using extra strength adhesives that provide long term bonding. The displays can be joined to the receiving base in several different ways, but studs with male threads and displays with incorporated female threads have received favorable attention. The receiving base can be utilized but not limited to the attachment of vases, potted plants, religious symbols or other personal items. A cavity lined with female threads located in the display's bottom or sides simplifies the union of the base and display. All displays can be attached or removed at the convenience of the user. Although designed primarily for cemetery display use, the invention can be utilized in other situations. The invention has substantial advantages over prior art because of its low cost and ease of attachment when placing it into service and switching the array of available displays. The invention will reduce cemetery maintenance costs and has the potential of reducing or eliminating restrictive existing cemetery policies.

### BACKGROUND OF THE INVENTION

The inventor with 35 years of experience in cemetery work is aware of the problems associated with cemetery displays. The technological advancement in the adhesive and plastics industries makes the invention a unique and timely one. It is unique because of its simplicity and how well that feature satisfies the need for solving a major problem; the nuisance caused by cemetery ground level displays. The cemetery display should not be placed at a level where it interferes with cemetery maintenance. The invention is comprised of two units, (1) an anchor receiving base composed of a flat adhesive backed base to which is attached a stud with male threads, and (2) displays having an incorporated bottom and side cavity lined with female threads and surrounded by a concavity. Both units are united when placed into service through the engagement of both sets of threads. The easy to use features and low cost will be incentives to replace ground-littering displays. There are products on the market, but as witnessed by their absence, they are not being placed into service. The invention's composition will favor, but not be limited to, molded plastics to keep it competitive with the ground level displays. Potted plants, flower-filled vases, religious symbols, encased photos or other personalized items will make up some of the displays. Policies set forth by cemetery administrators regulating the duration in which displays can be shown can be changed after the invention is placed into service. Public sentiment in the past has been affected by these restrictions. Eliminating the chore of handling the displays by maintenance personnel will also affect costs of cemetery up-keep.

### SUMMARY OF THE INVENTION

The present invention consisting of, but not limited to, cemetery displays in the preferred embodiment is comprised of two units. One unit, an anchoring base, and the companion unit, consisting of a plurality of displays that attach to the anchoring unit. The anchor base is bonded to the surfaces of the monument and its base by employing a strong long lasting adhesive. The adhesive is attached to the base bottom and is protected by a peel-off cover. Also included in the anchoring unit is a stud with either clockwise or counter-clockwise male threads. The companion unit consists of an array of bottom and side mounted displays that mate with the male threaded stud by means of cavities lined with matching female threads. The female lined cavity is surrounded by a concavity retrofitting the anchor base making both units appear to be a part of the substrata. The concavity with its camouflaging feature and stud with unusual threads offers the opportunity to deter tampering and theft of the displays. The easy-to-place in service feature, the array of displays, and its competitive price will provide incentives for the buying public. The use of the invention will correct the nuisance created by ground level displays which interfere with the maintenance of the cemetery grounds. Consequently, cemetery administrators will not be forced to set policies that limit the on-site stay of the displays.

A primary purpose of the invention is to provide a device that solves problems associated with displays, mainly those placed on cemetery grounds.

The invention provides an opportunity for attaching displays above ground level and does away with the clutter caused by ground level displays. It includes an array of displays that are affordable and easy to place into or remove from service when compared with prior art.

Another objective will be realized when cordial relations between cemetery administrators and the public are enhanced through the reduction or elimination of display removal deadlines.

Another objective will be realized when the public can remove the displays at their convenience and not at a prescribed time.

Another objective will be met when displays are not damaged when cemetery personnel no longer handle them during scheduled maintenance.

A further objective will be realized when the wide choice of displays are placed into service and the opportunity exists to easily switch them to fit the occasion.

Another objective will be realized when tampering and theft will be reduced through the blending effect achieved by the concavity retrofitting the anchor base and the unusual threading design.

Other advantages of the invention over prior art will become apparent when the accompanying descriptions and drawings are studied.

### DESCRIPTION OF THE PRIOR ART

Prior art discloses mainly flower vases for use in cemetery displays that can be, (a) stored underground, (b) cemented to monument bases without easy-on-easy-off features, (c) attached to strap metal that is forced beneath the monument making it difficult to place into or remove from service, (d) attached to male threaded metal studs that fasten to a metal female lined threaded hole drilled into the granite monument base. These features make it one of the most difficult and expensive arts to place into service. (e) mechanisms clamped onto the walls of the monument, (f) and a swivel or shelf attached to the monument or its base. The clamping mechanism, and the shelf and swivel are conspicuous and tend to clutter the focal point, the monument. The present invention does not possess these features. Rather, it tends to blend with the monument through the retrofitting process that unifies the display with the substrata. Prior art because of its costs and complexities has not created enough of an incentive to have people exchange the less expensive ground level displays for the more expensive inflexible ones. Essentially, the absence or sporadic use of prior art accounts for the clutter and nuisance created by the low priced ground level display.

### A BRIEF DESCRIPTION OF THE DRAWINGS

FIG. 1 Shown are the 3 main segments of most cemetery burial markers and a ground level marker. The concrete base is the longest and widest of the segments and is partially buried in the soil. It is the foundation for the monument and its base. The smooth polished surface of the monument and its base provide good bonding conditions for adhesives used in this invention.

FIG. 2 An overall view is shown of the main displays and a vase attached to the front face of the monument. The anchor base bottom is lined with extra strength adhesives. The opposite side has a stud that is mateable with the display. All the displays have incorporated cavities lined with female threads. The cavities are surrounded by concavities that provide a retrofitting for the anchor base. The anchor base in all cases has an adhesive protected by a peel-off cover.

FIG. 3 The extra 5 to 7 inches of space on the monument base ends are used to attach the shown displays. To better illustrate the features of the drawings, the monument has been reduced in length. The features of the anchor base and displays shown in FIG. 2 are also shown in this drawing. It should also be noted that the drawings in all illustrations are not to proportion.

FIG. 4 A plant pot with engaged fasteners are shown attached to the protruding end space of the monument base. Again the monument was cut away to better illustrate the way the display is attached. As stated before, the drawings are not sized proportionately. The concavity surrounding the threaded cavity serves its purpose in the best way in this display. However, it could be used in the same way if other types of fasteners were used that included the easy-on-easy-off features.

FIG. 5 A receiving base with a set of 3 studs and platforms to help stabilize the attached displays make this displaying process different from the previous ones. It will be most effectively used in the front of the monument attached to the extra space on the monument base. Ground level monuments shown along with the standard monuments in FIG. 1 can also be used in the displaying process. The triple display offers an opportunity to do some individual designing and will take the place of previous more expensive ground level displays the invention is designed to replace.

### DETAILED DESCRIPTION OF THE INVENTION

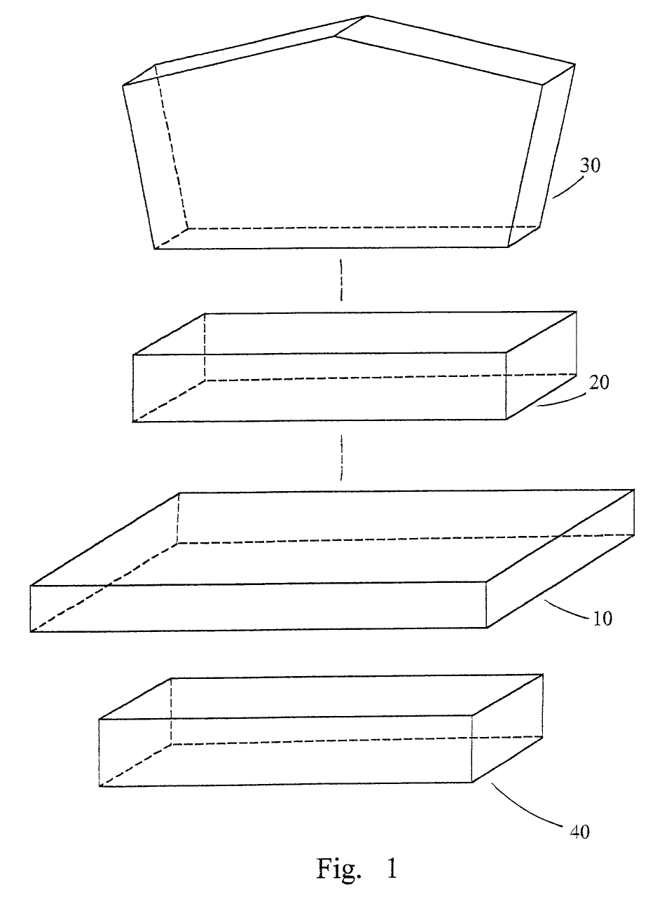

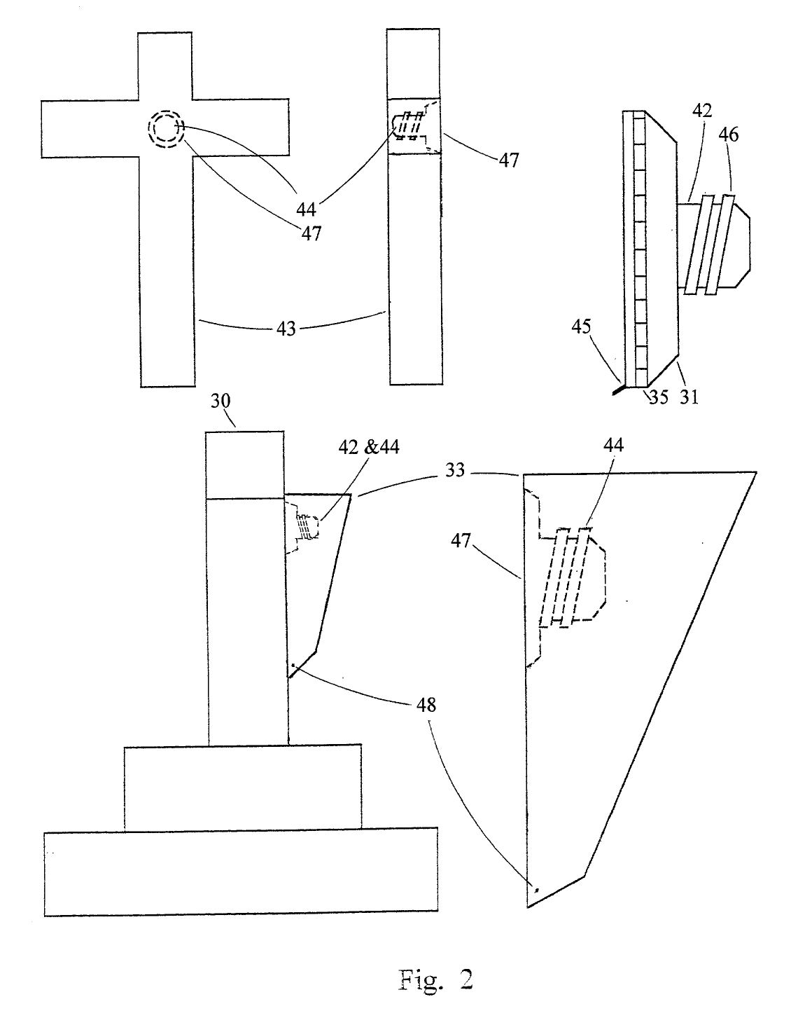

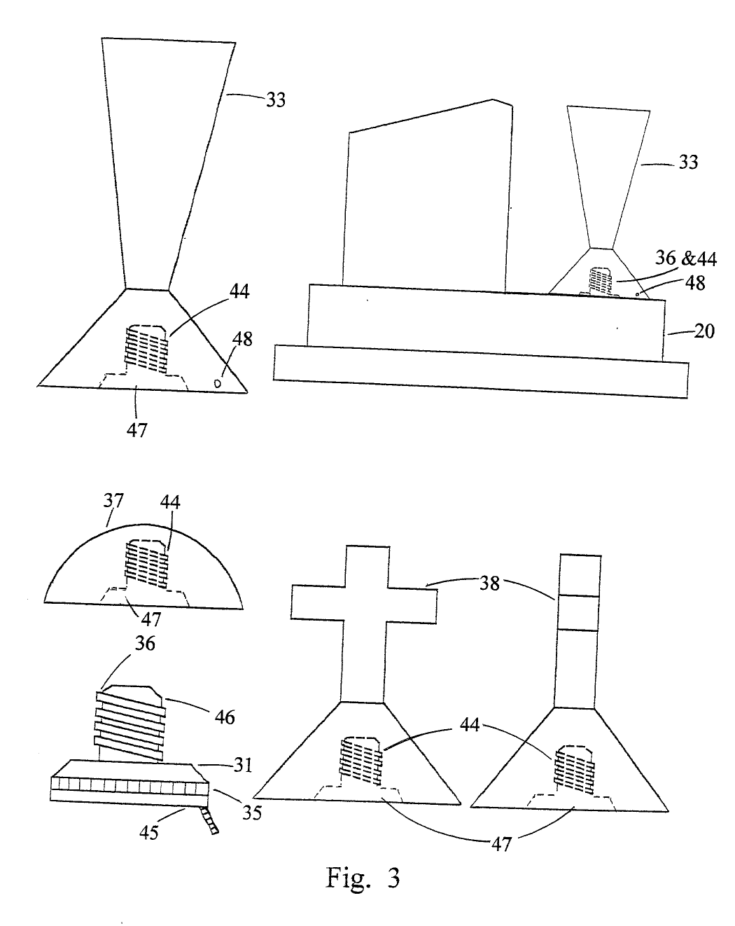

Segments of the most used cemetery burial markers are shown in FIG. 1. The concrete base 10 acts as the foundation for the monument 30 and its base 20. It is partially submerged in the soil and has the largest dimensions of the 3 segments. The extra length and width makes vegetation more accessible for trimming. The monument base 20 is bonded with an adhesive to the top of the concrete base 10. It is 6 to 8 inches wider and 10 to 14 inches longer than the bottom of the monument 30. The extra dimensions provides an area for attaching the bottom mount displays shown in FIGS. 3, 4, and 5 and makes the invention a workable one. The ground level monument 40 is growing in popularity. Its top is positioned at ground level and offers no problem during grounds maintenance. It has a smooth surface and can be used with all the bottom mount displays. The monument 30 is the focal point of the grave. It identifies the burial and is bonded to the top of the monument base 20. It and the monument base 20 features smooth polished surfaces which provides for excellent bonding conditions when extra strength adhesives are used in this invention. Once the invention is attached, the displays FIGS. 2-4 will stay in place for long periods of time.

The vase 33 and cross 43 illustrated in FIG. 2 are used for side mounting on the front, rear and sometimes the end of the monument 30. The anchor stud 42 with counter clockwise male threads 46 is shorter than the one 36 shown in FIGS. 3 & 4. The shortened version provides a neater appearance when narrow displays like the cross 43 are attached to the anchor base 31. The anchor base 31 has an adhesive 35 and a peel-off protective cover 45 attached to the bottom of the base 31. The concavity 47 surrounding the female threaded cavity 44 retrofits the anchor base 31. The retrofit has a blending effect between the displays and the substrata. The counter clockwise threads and the retrofit offers an opportunity to deter tampering and theft of the displays. Counter clockwise threads are shown in all drawings, but this does not preclude the use of clockwise threads.

FIG. 3 shows the features of bottom mount displays 33 & 38 and an off-season covering 37 for the anchor base and its threaded stud 42. The bottom mounts with the mateable threads engaged are attached to the surfaces of the monument base 20 and ground level monument 40 shown in FIG. 1. The anchor base 31 with its longer male stud 36, male threads 46, and adhesive 35 protected by a peel-off cover 45 are used in the anchoring process. However, a shorter stud 42 like the one shown in FIG. 2 will suffice. The vase 33 has a water drain hole 48 at its bottom. The female threaded cavity 44 surrounded by a concavity 47 are shown incorporated in displays 33, 43, and 47. To more effectively show the attachment of the vase 33 to the monument base 20 part of the monument 30 has been cut away in the drawing.

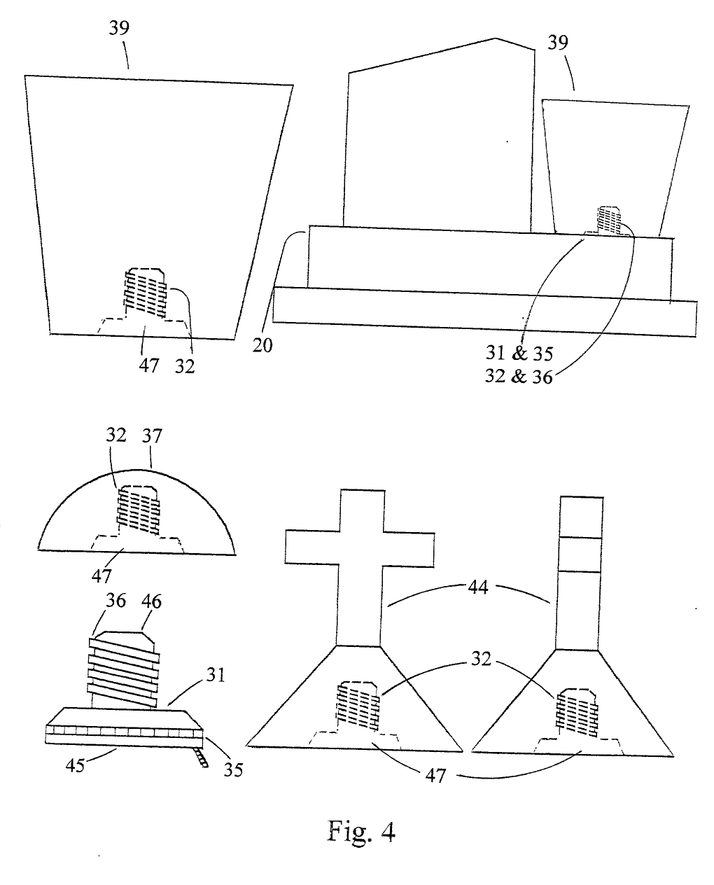

A plant pot 39 in FIG. 4 is attached to a bottom mount anchor base stud 42 by engaging the male threads 46 with the female threads 44 located in the incorporated cavity of the pot. The concavity 47 is an important feature in this display. It allows the base 31 to mesh with the pot 39 bottom. The pot 39 with its extra weight rests mainly on the monument base instead of the anchored base 31. The invention's quick-change feature allows exchanging the pot 39 for another display when the living plants lose their appeal. The cross 38 or the off-season cover 37 can be used in this situation. The monument 30 in this illustration has also been cut away to more effectively show the displays attachment.

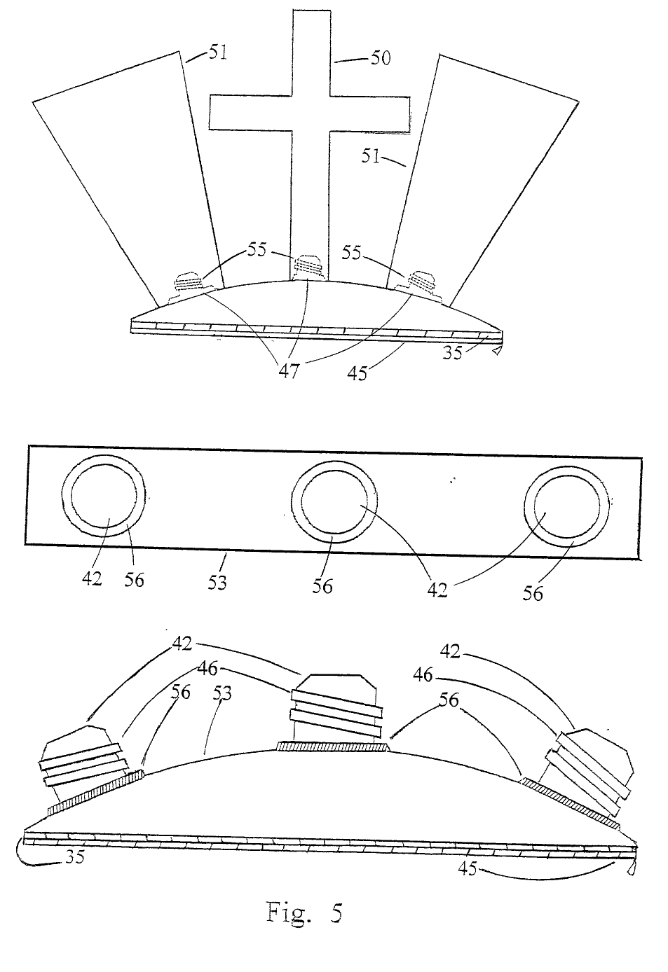

The features of the invention shown in FIGS. 1, 2, 3, & 4 are also shown in FIG. 5. However, this display is designed for a combination of displays. The cross 50 is surrounded by two vases 51. The triple display will be attached in front of the monument 30, but will be bonded to the extra space on the monument base 20. The receiving base 53 is larger than those shown in the previous illustrations. The studs 42 show only two counter-clockwise threads 46 surrounded by a circular platform 56. The display's concavity 47 will enclose the platform 56 and will help stabilize the mounted displays 50 & 51. The arch-like shape of the receiving base 53 provides the space needed for engaging the multiple displays. After the displays are engaged through the use of the mateable threads 46 and 55, complete the attachment to the monument base by removing the protective cover 45 from the adhesive 35 and firmly press the base 53 onto the pre-selected space on the monument base 20. The drawings are not in proportion to better show the details.

The preceding drawings of the invention include several preferred examples, but it should be understood that the invention is not limited to those shown. Any modification of the invention can be included as long as it does not depart from the invention's stated scope and purpose. The product can be made of various materials, but the inexpensive molded plastics would be in keeping with the intent of the invention making it competitive with the displays it is intended to replace.

What is claimed:

1. Mateable devices for mounting and displaying pre-selected items, comprising
a. An anchoring base featuring a fastener on one side and a bonding agent on the opposite side.
b. And a plurality of items for display having incorporated bottom and side concavities surrounding cavities that accept said fastener.
Whereby prior art's noticeable absence of use is evidence of not providing a solution to problems described herein; the features of the invention described and illustrated herein offers an opportunity to solve said problems.
